(19) United States
(12) Patent Application Publication
(10) Pub. No.: US 2025/0296537 A1
(43) Pub. Date: Sep. 25, 2025

(54) A SYSTEM FOR CONTROLLING A FORCE APPLIED ON A TRAILER BEING TOWED BY A VEHICLE

(71) Applicant: RED AUTOMOTIVE TECHNOLOGIES PTY LTD, south Australia (AU)

(72) Inventors: Michael Joseph DUKE, Pooraka SA (AU); Paul VAN DE LOO, Norton Summit SA (AU)

(21) Appl. No.: 18/852,905

(22) PCT Filed: Mar. 29, 2023
(86) PCT No.: PCT/AU2023/050233

§ 371 Date: Sep. 30, 2024

(30) Foreign Application Priority Data
Mar. 29, 2022 (AU) 2022900789

(51) Int. Cl. B60T 8/17; B60W 10/08; B60W 10/18; B60W 30/18; B62D 63/08

(52) U.S. Cl. CPC B60T 8/1708; B60W 10/08; B60W 10/18; B60W 30/18127; B62D 63/08; B60W 2510/184; B60W 2530/207

(57) ABSTRACT

A system is operable for controlling a force applied on a trailer being towed by a vehicle is described to a desired force Fd. The trailer has brakes and an optional motor for providing a propelling force to the trailer. A force sensor senses fore-aft forces between the vehicle and trailer at all times while the trailer is being towed. A controller receives signals from the force sensor and is operatively connected to the trailer brakes and the motor. The system controls the force between a towing vehicle and a trailer to the desired force Fd, by any one of: (a) operating the brakes to apply a braking force to the trailer; (b) activating the motor to apply a propelling force to the trailer; and (c) operating the brakes and activating the motor to apply both a braking and a propelling force to the trailer.

### FIELD OF THE INVENTION

The present invention relates to a system for controlling a force applied on a trailer being towed by a vehicle.

### BACKGROUND OF THE INVENTION

Trailers are commonly towed by vehicles on and off road. For example, on-road trailer caravans, horse floats and general goods carrying trailers towed behind passenger vehicles.

Trailers are also often towed behind trucks, greatly increasing their load transportation ability.

Trailers are connected to vehicles using tow hitches. Those used on passenger vehicles typically consist of a ball joint comprising a tow ball on a tow bar on the rear of the vehicle and a female receiver on the trailer. This connection is also often termed a coupling, with the two mating components termed couplers. Other tow hitches separate the rotation axes into separate pivots, but the centre of rotation of each rotation axis is typically located at or near the same point, and at basically the same location, as a ball joint type hitch.

Before continuing with a background description, and to ensure consistency in the language used throughout this specification, it should be understood that terms designating direction, such as forward and aft, will be used throughout this specification in the context of a vehicle-trailer combination on a roadway travelling in a normal direction, that is with the vehicle forward of the trailer.

Further, the terms pushing and pulling relate to the direction of a force exerted by the trailer onto the rear of the car via the trailer hitch and the vehicle's towbar. These forces are primarily in the fore/aft or longitudinal direction. When discussing the magnitude of a force, this is in the context of a pushing or compressive force in the coupling being positive and a tension or pulling force being negative. When the force is described as increasing it may already be a compressive force (positive) or it may be a tension (negative) force but is tending towards compressive. Similarly, when the force is described as decreasing it may already be a tension force (negative) or it may be a compressive (positive) force but is tending towards tensile.

Braking of trailers in an optimal way is a challenge for existing systems. Optimally a trailer braking system will ensure that the trailer does not apply a burden on the brake system of the towing vehicle—primarily by avoiding pushing the vehicle along when braking. The trailer braking system also should not take an excessive share of the braking (where the trailer will tend to pull on the vehicle when braking), as this will tend to result in the trailer brakes overheating and malfunctioning. Optimally these aims will be met under all conditions, not just braking when travelling in a forward direction, but also braking when reversing, parked on inclines, etc.

There are a number of trailer braking systems that are in use.

A common type of trailer braking systems is of a surge or override type. Such trailer braking systems use the force of the trailer pushing on the vehicle when the vehicle applies its brakes to actuate the trailer brakes. This is typically done either hydraulically or using a cable. In hydraulic systems a hydraulic cylinder at or near the trailer coupling is depressed against spring pressure when the longitudinal pushing force is present and provides hydraulic pressure to hydraulically actuate brakes on the trailer wheels. In cable systems relative movement at or near the trailer coupling resulting from trailer pushing force against a spring pulling on cables which operate mechanically actuated brakes at the trailer wheels.

A significant disadvantage of surge or override types is that, when reversing, the brakes will tend to be applied. Typically, a lock-out latch is provided at the coupling that prevents the relative motion that activates the brakes. The driver of the vehicle must manually apply this prior to reversing. If the driver forgets to take this off again before resuming forwards travel the trailer brakes remain inoperative—with obvious safety implications.

A further disadvantage is that the trailer brakes will not apply when stationary or reversing on an incline when facing up hill. With heavy trailers on steep slopes this can result in the trailer pulling the vehicle downhill backwards. A notable example is when reversing a heavy boat and boat trailer down a boat ramp—on application of the brakes the lack of trailer braking can cause the vehicle to skid backwards down the ramp due to being pulled backwards by the heavy boat/trailer.

A further disadvantage of the surge or override systems is that it can be unstable when the trailer has powerful brakes. On application the brakes will result in the trailer slowing quickly, causing the trailer to pull on the vehicle causing the trailer brakes to be released. Whilst the vehicle is still braking, this will result in the trailer again pushing on the vehicle, causing the trailer brakes to be reapplied. The cycle then repeats. This unstable braking control leads to a loss of braking efficiency and the cyclical jolting on the vehicle can lead to a loss of directional control of the vehicle.

Another type of trailer braking system is electrically actuated brakes. A controller in the vehicle senses the application of the vehicle brakes, typically by monitoring the brake light signal and sensing deceleration of the vehicle via an accelerometer or pendulum. The controller then provides an electrical signal to the trailer brakes which cause them to apply.

Typically, an electromagnet at the brake is energised and comes onto contact with the brake drum. The force generated by the rotating motion of the drum on the stationary electromagnet pulls on a lever to which it is mounted with substantial mechanical advantage to mechanically apply the brake shoes. The electromagnet uses an inductive coil to create a magnetic field to attract the coil to the brake drum.

Electrically actuated brakes are also taken to include any that use an electronic or electrical signal to the trailer braking system but the actual actuation of the brake pads or shoes or equivalent is done by other means such as hydraulically. Such brakes are also referred to as “electric over hydraulic brakes”.

Electric Brakes Also Suffer from a Number of Disadvantages:

It is difficult for a vehicle controller to judge the correct amount of braking to ensure that, when braking, the trailer is not pushing or pulling on the vehicle. Fundamentally the controller cannot accurately discern what portion of the deceleration it is sensing due to the trailer brakes and what portion is due to the vehicle brakes. Such controllers thus typically allow users to tune the gain on the signal sent to the controller—thus relying on the user to solve this conundrum. However, this is not reliable—drivers have no reliable way of sensing where braking is emanating from. The appropriate gain may also vary under different braking conditions, such as when the brakes start to overheat and lose effectiveness, or when the vehicle is also using engine braking.

As with surge brakes, electric brakes typically will not apply when stationary or reversing on an uphill incline. Most brake controllers can provide braking when the driver presses a switch or control on the controller's user interface—enabling a driver to manually apply the brakes in such scenarios. This however relies on driver skill and experience to remember to activate the trailer brakes in this manner and also to maintain the correct level of braking—particularly difficult when trying to reverse downhill.

Unlike surge brakes, electric brakes require that the vehicle be equipped with a controller.

On hitching, electrical connections must be made—typically, this is done with the same connector that provides electrical signals for the various lights on the trailer—such as indicators, brake lights and tail lights. Such electrical connectors are not universal—so even a vehicle equipped with a controller may not have the correct connector for a particular trailer. A further challenge is that the power required for electrical brakes is large—often bigger than can be reliably provided by trailer connectors. In some applications a separate high current capacity connector is used to transmit the necessary current—further making the connection non-standard. Such issues make trailer towing less flexible, such as when hiring a trailer, the vehicle not being compatible with the hire trailer. This is a disadvantage as it precludes any vehicle from towing a particular trailer.

Heavy vehicles and those that tow a trailer all or much of the time typically use air brakes. Air brake systems provide modulated air pressure to each brake both on the vehicle and the trailer. The vehicle must be fitted with an air compressor and a compressed air storage tank. The tank is physically large—which is a disadvantage on light vehicles which tend to be smaller. The air compressor is typically engine driven. The cost and complexity of this is more of a burden in lighter, cheaper vehicles. The brake pedal operates an air valve that modulates the air pressure sent to the brakes. The force required by the driver to apply the brake is typically solely provided by a return spring, thus the further the pedal is depressed and valve opened the greater the pedal force required. This arrangement provides less tactile feedback or “feel” through the brake pedal of the amount of braking effort being applied than the hydraulic brakes typically used on light vehicles. Air brakes can be readily configured to be fail safe—where brake actuators are fitted with “Maxi brake” actuators that are spring actuated and apply automatically if air pressure is lost.

For the above reasons air brakes are typically only used on heavy vehicles. The air is supplied to the trailer via an air line with a connector that can be readily disconnected (and automatically plugs to avoid the loss of air whilst disconnected).

Light vehicles typically use hydraulic braking systems which are not amenable to extension to a trailer in a non-permanent fashion. It is this class of vehicle which necessitate the use of surge/override brakes or electric brakes such as those described earlier.

Braking of vehicles that are propelled solely or partially by one or more electric motors introduces the possibility of regenerative braking. This involves each electric motor acting as a generator, converting the vehicle's kinetic energy into electricity. The electricity can be used to recharge batteries to power the electric motors and thus propel the vehicle.

Whereas trailers, particularly heavier ones, typically have braking systems as described above, they can also have propulsion systems. These may merely assist in propelling the trailer, with the vehicle providing most of the propulsion. In this case the vehicle still pulls the trailer most of the time when travelling along a roadway. More powerful trailer propulsion systems provide the option for the trailer to help propel the vehicle. In this case the trailer may push the vehicle most of the time when travelling along a roadway.

The trailer propulsion system may be electric, using one or more electric motors to propel the trailer. A battery mounted to the trailer may provide the power to drive the electric motors. When braking, the electric motors may generate power to recharge the battery. This regenerative braking may comprise some or all of the braking of the trailer.

Embodiments of the current invention attempt to control the force between a vehicle and a trailer to a desired force.

### SUMMARY OF THE INVENTION

In one aspect there is disclosed a system for controlling a force applied on a trailer being towed by a vehicle, the system comprising:
a force sensor configured to sense a force between the vehicle and the trailer and being arranged to generate an electrical force signal as a function of the force; and
a controller in electrical communication with the force sensor, the controller arranged to control: (a) at least one propulsion system of the trailer; or (b) at least one brake of the trailer; or (c) both at least one propulsion system and at least one brake of the trailer, in a manner such that the force sensed by the force sensor at least approaches a desired force.

In one embodiment the desired force is substantially zero.

In one embodiment the system comprises a drawbar and/or a coupling for coupling the vehicle and the trailer to each other, wherein the force sensor is in use located in or at the drawbar or the coupling and is configured to sense a substantially longitudinal force between the vehicle and the trailer.

In one embodiment the controller is arranged to generate an output signal that is directed to the at least one brake of the trailer and is modulated to vary a braking force applied by the at least one brake.

In one embodiment the controller is arranged to generate an output signal that is directed to the at least one propulsion system of the trailer and is modulated to vary a propulsion force generated by the at least one propulsion system.

In one embodiment the controller is arranged to generate output signals that are directed to the at least one brake of the trailer and the at least one propulsion system of the trailer and are modulated to vary a braking force applied by the at least on brake and/or a propulsion force generated by the at least one propulsion system.

In one embodiment the controller is arranged to enable a user to adjust the desired force.

In one embodiment the controller is arranged to control the at least one propulsion system and/or the at least one brake to initiate an emergency braking of the trailer when the force sensor senses heavy braking of the vehicle.

In one embodiment the system is arranged for sensing a quantity indicative of a temperature or a change in temperature of a portion of the at least one brake of the trailer.

In one embodiment the system is arranged to sense a measure for the temperature of the brakes by sensing a resistance of an inductive coil used in the brakes.

In one embodiment the controller is arranged to control braking of the trailer based on a temperature sensed at the at least one brake of the trailer.

In one embodiment the controller is arranged to reduce braking of the at least one brake of 30 the trailer when the temperature sensed at the least one brake of the trailer is above a predetermined threshold temperature.

In one embodiment when the trailer includes at least one electrically actuated brake, the system for controlling the force is directly or indirectly electrically coupled to the at least one electrically actuated brake.

In one embodiment when the trailer includes a propulsion system, the controller controls the propulsion system such that the propulsion system is able to provide a braking force on the trailer.

In one embodiment the propulsion system includes at least one electric motor.

In one embodiment the controller controls the at least one electric motor to operate as an electric generator to generate electricity and provide a regenerative braking function and thereby at least a portion of the braking force on the trailer and wherein the generated electricity is used to recharge a battery.

In one embodiment when the trailer comprises friction brakes, the system for controlling the force is arranged to control the at least one electric motor and the friction brakes such that a first portion of the braking force is provided by the friction brakes and a second portion of the braking force is provided by the regenerative braking function of the at least one electric motor.

In one embodiment the system comprises an apportioner which determines a relative size of the first portion of a required braking provided by the friction brakes and the second portion of a required braking provided by the regenerative braking function of the at least one electric motor.

In one embodiment the apportioner determines the relative size of the first portion of the braking force provided by the friction brakes and the second portion of the braking force provided by the regenerative braking function of the at least one electric motor in a manner such that a charge of the battery is maximised.

In one embodiment the apportioner determines the relative size of the first portion of the braking force provided by the friction brakes and the second portion of the braking force provided by the regenerative braking function of the at least one electric motor in a manner such that braking of the trailer is maximised in case of a detected emergency event.

In one embodiment the apportioner determines the relative size of the first portion of the braking force provided by the friction brakes and the second portion of the braking force provided by the regenerative braking function of the electric motor in a manner such that a temperature at the trailer brakes does not exceed a threshold temperature.

In one embodiment the apportioner determines the relative size of the first portion of the braking force provided by the friction brakes and the second portion of the braking force provided by the regenerative braking function of the at least one electric motor in a manner such that a temperature of any one of the at least one electric motor does not exceed a threshold temperature.

In one embodiment the at least one propulsion system comprises two or more electric motors and wherein the system is arranged to provide anti-lock braking and/or traction control of the trailer.

In one embodiment the controller and the force sensor form part of a feedback loop in which the controller controls the force applied to the trailer such that the actual/sensed force tends towards the desired force overtime.

In one embodiment the controller incorporates one of (a) a proportional-integral-derivative controller (PID) controller; (b) an optimal control-based strategy including a Linear-Quadratic-Regulator; (c) a Model Predictive Control strategy; and, (d) a stochastic control-based system including a Linear Quadratic Gaussian control system.

In one embodiment the force sensor is configured to determine a tensile force.

In one embodiment the force sensor is configured to determine a compressive force.

In one embodiment the system is arranged such that the force sensor senses a tensile or compressive force when a tensile or compressive force, respectively, is applied between the trailer and the vehicle.

In one embodiment the system comprises a sensing element mechanically or hydraulically coupled to a coupling between the vehicle and the trailer that directly experiences the force between the vehicle and the trailer, the sensing element further coupled to the force sensor whereby the force sensor can be located remotely from surfaces which directly experience the force between the vehicle and the trailer.

In one embodiment the force sensor comprises a mechanical arrangement, such as a compliant member or spring, and a displacement sensor.

In one embodiment the system comprises an accelerometer and wherein the system is arranged such that the accelerometer senses an acceleration or a change in acceleration of the vehicle and produces a signal that can be processed by the controller and used to determine the force to be applied to the trailer.

In one embodiment the system further comprises a speed sensor configured to sense a speed of the vehicle and the trailer and arranged to generate an electrical speed signal as a function of the force; wherein the controller further used the electrical speed signal to control the at least one propulsion system of the trailer and/or the at least one brake of the trailer.

In one embodiment system of any one of the preceding claims wherein the controller includes a manual override facility enabling a user to input a signal to apply the brakes of the trailer.

In a second aspect there is disclosed a method of controlling a force applied on a trailer being towed by a vehicle, the method comprising the steps of:
a. sensing a force between the vehicle and the trailer and generating an electrical force signal as a function of the force; and
b. controlling: (i) at least one propulsion system of the trailer; or (ii) at least one brake of the trailer; or (iii) both at least one brake and at least one propulsion system of the of the trailer, in a manner such that the sensed force at least approaches a desired force.

In one embodiment method of the second aspect uses the system of the first aspect.

The invention will be more fully understood from the following description of specific embodiments of the invention. The description is provided with reference to the accompanying drawings.

### BRIEF DESCRIPTION OF THE DRAWINGS

FIG. 1 is a schematic representation of a trailer being towed by a vehicle and having a system for controlling a force applied on the trailer in accordance with an embodiment of the present invention;

FIG. 2 is schematic representation of the system for controlling a force applied on a trailer being towed by the vehicle;

FIGS. 3 and 4 are block diagrams of the system for controlling a force applied on the trailer being towed by the vehicle in accordance with an embodiment of the present invention;

FIGS. 5 (a), (b), (c) and (d) illustrate components and function of a system for controlling a propulsion system of the trailer being towed by the vehicle in accordance with a further embodiment of the present invention;

FIG. 6 is a block diagram of the system for controlling braking of the trailer being towed by the vehicle in accordance with the further embodiment of the present invention;

FIG. 7(a) is a representation of a twin axle trailer with one axle fitted with friction brakes and an electric motor that provided both regenerative braking and propulsion and the other axle fitted with friction brakes only;

FIG. 7(b) is a block diagrams of a further embodiment of the disclosed system for controlling braking of the twin axle trailer shown in FIG. 7(a); and

FIGS. 8 to 11 are graphs illustrating trailer velocity and tow hitch forces of the vehicle pulling the trailer for different operating scenarios and using the system in accordance with an embodiment of the present invention.

### DETAILED DESCRIPTION OF SPECIFIC EMBODIMENTS

Embodiments of the present invention provide a system for controlling a force applied on a trailer being towed by a vehicle. The system is operational at all times while the trailer is being towed, i.e., this includes: when travelling at a constant speed; during acceleration; during deceleration; travelling uphill or downhill; and, when cornering. In a most general form one embodiment of the invention contemplates controlling the force between a towing vehicle and a trailer to a desired force by any one of: (a) applying a braking force to the trailer; (b) applying a propelling force to the trailer; and (c) applying both a braking and a propelling force to the trailer.

While an embodiment of the system may be arranged to apply control any one of (a), (b) and (c) above; dependent on the nature of the towing vehicle and the trailer the system may only be able to apply one. For example, if the trailer has a braking facility but does not have a propulsion system, then the system for controlling a force applied on a trailer, can only do so by controlling the braking force on the trailer. In this instance the system is still ON in the sense that it is sensing the force between vehicle/trailer, but it is only active to control the braking of the trailer when it senses that braking is required, as determined by the controller from for example, but not limited to, a brake light signal.

In a first embodiment of the present invention, which will initially be described, the system controls braking of a trailer being towed by a vehicle. In a second embodiment of the present invention, which will be described further below, the system also controls a propulsion capability of the trailer being towed by a vehicle.

The system in accordance with the first embodiment has a force sensor configured to sense a force between the vehicle and the trailer and which is arranged to generate an electrical force signal as a function of a sensed force. The system further comprises a controller in electrical communication with the force sensor. The controller is arranged to generate an output signal to control the braking of the trailer in a manner such that the force sensed by the force sensor at least approximates a desired force, which may approximate zero.

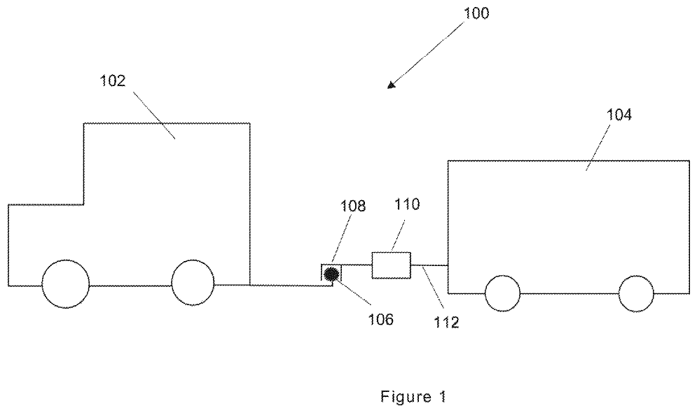

Referring initially to FIG. 1, the system 100 for controlling a force applied on a trailer being towed by a vehicle is now described in further detail. FIG. 1 shows a vehicle 102 towing a trailer 104. The trailer 104 is connected to the vehicle 102 by the tow hitch which comprises a tow ball 106 mounted to a vehicle tow bar and tow ball receiver 108 connected to the trailer 104. The system 100 comprises a force sensor 110 which is mounted to a trailer drawbar 112 such that fore-aft forces between the vehicle 102 and trailer 104 are sensed. The system 100 further comprises a controller (not shown) located in the trailer 104. The force sensor 110 is in electrical communication with the controller, which in turn is in electrical communication with brakes (not shown) at wheels of the trailer 104. The controller is in communication (wired or wireless) with the vehicle 102 to receive information concerning a brake light signal from the vehicle 102 and information from a user interface (not shown).

The force sensor 110 measures the fore/aft force between the trailer 104 and the vehicle 102. The force sensor 110 is typically mounted on the trailer 104, but can alternatively also be mounted on the vehicle 102. A convenient location to mount the force sensor 110 on the trailer 104 is in a load path in the drawbar or between the coupling and the drawbar. When mounted on the vehicle 102, the force sensor 110 will measure a slightly different force than that measured when mounted on the trailer 102 when the vehicle 102 and the trailer 104 are not aligned, such as when travelling around a corner. In practice this is not of great consequence as the difference is not large at small relative angles. Further, heavy braking usually occurs when the vehicle 102 and trailer 104 are travelling in a substantially straight line and an angle between the vehicle 102 and the trailer 104 is negligible.

The force sensor 110 can take many forms. For example, the force sensor may be based on a strain measurement gauge to determine stress in a structural member, such as the drawbar. In this case the force sensor 110 is mounted to the drawbar and senses fore/aft stress in the structure. The force sensor 110 generates an electrical output signal proportional to strain which can be converted to force.

A person skilled in the art will appreciate that force does not need to be measured directly at the coupling between the vehicle and the trailer. Rather in one embodiment the system may include a sensing element mechanically or hydraulically coupled to a coupling between the vehicle and the trailer that directly experiences the force between the vehicle and the trailer, with the sensing element further being coupled to the force sensor. In this way the force sensor can be located remotely from surfaces which directly experience the force between the vehicle and the trailer. In an example of a hydraulically coupled sensing element, a hydraulic cylinder is inserted into the load path and with a pressure sensor to measure hydraulic fluid pressure in the cylinder. When the pressure is multiplied by the active area of the cylinder, the force in the cylinder is found. A way of inserting the cylinder in the load path would be to join the coupling to the drawbar with the cylinder, aligned in the fore aft direction.

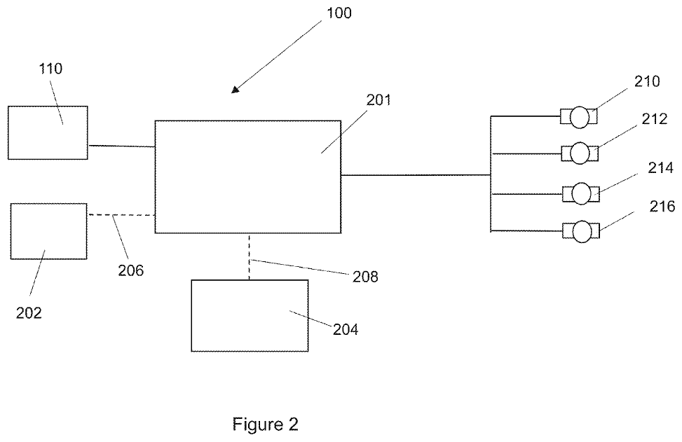

An example of a mechanically coupled sensing element is a compliant element added into the load path in the drawbar, such as between the coupling and the drawbar, that is compliant in the fore/aft direction. Here the force sensor 110 also includes a displacement sensor that is used to measure the movement in this compliant element in the fore/aft direction. A controller 201 of the system 100 (which is not shown in FIG. 1, but will be described further below with reference to FIG. 2) calculates the force being transmitted through the compliant element as the product of deflection measured by the displacement sensor and the spring rate of the compliant element.

The controller 201, which may or may not comprise a microprocessor, is arranged to receive input signals concerning brake light (or an equivalent signal that indicates that the driver has applied the brakes on the vehicle 102 or intends to drive the vehicle 102 in a reverse direction), a force sensor signal and optionally an input signal from a user interface. Further, the controller may optionally also receive signals from a speed sensor and an inertial sensor, such as an acceleration sensor. The input signals from a user interface can for example include information concerning a desired force that is sensible at the force sensor 110 when braking. The desired force typically is zero, but may be a positive compressive force such as a force resulting from long downhill towing of larger trailers towed by passenger vehicles. In this event it may be desirable for the vehicle 102 to contribute more to the overall braking because the brakes of large trailer are typically poor at dissipating heat. Further, the user interface may have a manual over-ride facility enabling a user to input signals for example to apply the brakes of the trailer 104. That is, the manual override enables the user to control the application of the trailer brakes. When the user demands braking, the user modulates or changes an input to the controller (for example by pressing a spring-loaded button). The controller then directs an output signal to the brakes to apply the brakes accordingly. Preferably the braking effort applied by the brakes is proportional to the level of braking demanded by the user. This is typically the way it is done in conventional brake controllers.

Referring now also to FIG. 2, the function of a system for controlling a force applied on a trailer 104 being towed by a vehicle is described in further detail. FIG. 2 illustrates the system 100 which comprises the controller 201. The force sensor 110 generates an electrical force signal which is directed to the controller 201 to inform the controller 201 of the force being sensed at that instant (or with very small delay—ideally less than 20 milliseconds). The controller 201 also receives an electrical signal from a brake light circuit 202 of the vehicle 102 or the trailer 104 which indicates that the driver of the vehicle 102 has applied the brakes. The controller 201 also communicates with a user interface 204. The dashed lines 206 and 208 indicate links via which communication may be established. These links are in this embodiment established using a wired connection including by a binary DC voltage signal, a data bus, either serial or parallel. But in an alternate embodiment the links 206, 208 can be established in a wireless manner. Data may flow in both directions. The controller 201 generates electrical output signals which are received by the electric brakes 210, 212, 214 and 216 of the trailer 104. Typically, a trailer will have electrically actuated friction brakes on all of its wheels (typically 2, 4 or 6 wheels). The output signal from the controller 201 to each brake is modulated by the controller 201, such that each brake applies the desired amount of braking effort. The controller 201 may be arranged to modulate the output signal to each brake separately or alternatively the same output signal may be applied to all brakes. Separate modulation would typically be used if the controller 201 incorporates an anti-lock braking function or a stability control or anti-sway function.

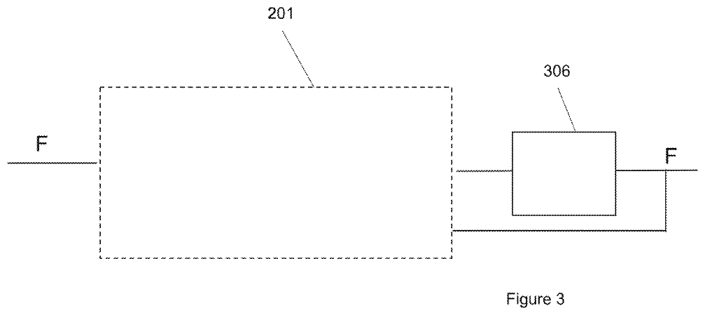

FIG. 3 schematically illustrates a control system diagram including the controller and plant 306. The control system diagram includes the controller 201 which controls the “plant”—the item under control—in this case the trailer and its brakes. The controller 201 is arranged to implement an algorithm for controlling the plant 306 of the trailer 104 when it is desired to apply the trailer brakes. Typically, braking of the trailer 104 is only desired when the towing vehicle brakes are applied, though there may be exceptions, such as when the towing vehicle 102 is using solely engine braking and a similar level of braking from the trailer 104 is desired. By implementing the algorithm only at these times when the vehicle brakes are applied, the presence of a sensed force at the force sensor 110 (not shown in FIG. 3), which transmits force signal “F” to the controller 201 will not cause the trailer brakes to be applied at other times.

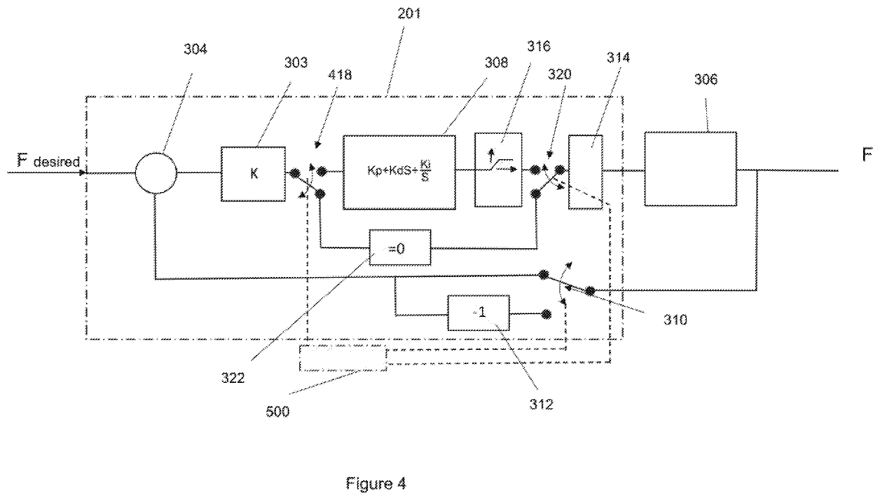

Referring now to FIG. 4, the function of components of the controller 201 are described in further detail and like components are given like reference numerals. The force F is sensed at the plant 306 and transferred back to a comparator of the controller 201 to generate an error signal that is input into a control block of the controller 201. In the described embodiment the force F is sensed at the plant 306 (trailer and its brakes) and transferred back to a comparator 304 of the controller 201 where it is subtracted from a signal related to a desired force “F desired”, which may relate to a desired force as selected by a user via the user interface described above, though not shown in FIG. 3. A resultant difference is then multiplied by gain multiplier 303. This resultant product is then applied to a proportional-integral-derivative (PID) control block 308. The PID control block 308 has proportional, derivative and integral gains of Kp, Kds and Ki/s, respectively. Note that the letter “s” represents the complex frequency in the Laplace domain. The output of the control block 308 is transmitted to the brakes of the plant 306 causing the desired level of braking force to be applied to the trailer wheels. As will be well understood by those skilled in the art, the integral (I) term in the PID controller 201 enables the controller and system to be able to reach a zero-error steady-state braking condition (such as a constant rate of deceleration when braking to a stop, or a constant speed of descent down a steep hill) while attaining accurately the desired force at the force sensor.

For operating scenarios where the feedback polarity must be reversed, such as when reversing, switch 310 is used to divert the signal “F” through block 312 where its polarity is reversed. The switch 310 may be implemented as a physical electrical switch and block 312 as an inverter, such as an inverting operational amplifier. In one specific embodiment however both the switch 310 and the inversion by the inverter 312 are performed in code on a microprocessor after the force signal is input into the microprocessor in appropriate form.

An amplifier 314 increases the power of the controller signal sufficiently to energise the brakes in the plant (trailer plus brakes) 306 in accordance with the command of the control block 308.

A clamp 316 limits the output to the amplifier 314 to avoid inputs to the amplifier 314 that cannot be utilised. Negative voltages or inputs are changed to zero. This is required as the brakes of the plant 306 can, and are required to, only respond to a positive signal. Inputs (e.g., voltages) that exceed, when amplified, the maximum signal that the brakes can utilise, are reduced to this maximum value.

Switches 418 and 320 clamp the input to the amplifier 314 to zero using clamp 322 when braking is not required. This prevents the integrator and differentiator operating when braking is not required. When brakes are required for example as determined by brake lights being on, the integral and differential terms in the PID control block 308 are first reset to zero before integration and differentiation restart.

The system may also comprise a supervisory controller 500 indicated using dashed lines in FIG. 4. The supervisory controller 500 comprises a microprocessor. The supervisory controller 500 reads inputs relating to force transducer, brake lights, reversing lights and then determines an operating scenario the trailer is in. It then ensures, such as by controlling switches 418, 320 and 310, that the controller 201 implements the appropriate control for the scenario at hand. The operating scenarios will be described further below.

The system for controlling a force applied on the trailer in accordance with a second embodiment of the present invention will now be described. In this embodiment the system for controlling a force applied on the trailer is also arranged to control a propulsion capability of the trailer. The propulsion capability can for example be provided using an electric motor to one or more of the wheels of the trailer. The electric motor may be powered by a rechargeable battery pack on the trailer or on the vehicle and is used to propel the trailer and possibly also the vehicle. The electric motor can also be used to provide braking. Moreover, the electric motor can be used to provide regenerative braking.

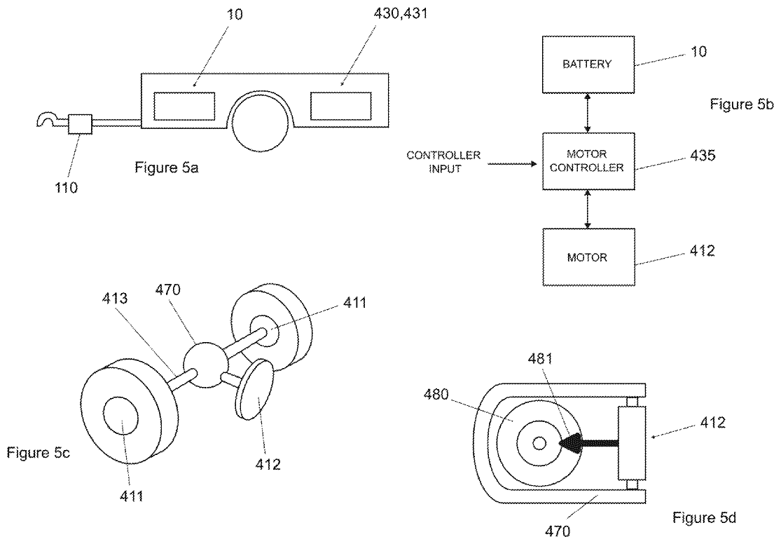

The system for controlling force applied to the trailer in accordance with a second embodiment of the present invention is now described with reference to FIGS. 5 to 7. The system relates to the system described with reference to FIGS. 1 to 4 and like components are given like reference numerals. A number of options for propulsion architecture are shown. A simple option, illustrated in FIGS. 5 (a), (c) and (d) is a single axle trailer where an electric motor drives both wheels via a differential. Conventional friction brakes, electrically actuated, are fitted to both wheels. This arrangement provides for propulsion, regenerative braking and friction braking at each wheel. Importantly, both friction braking and regenerative braking can be applied to each wheel at the same time. This allows regenerative braking to be used to its maximum capacity, and any shortfall in braking effort is made up with friction braking.

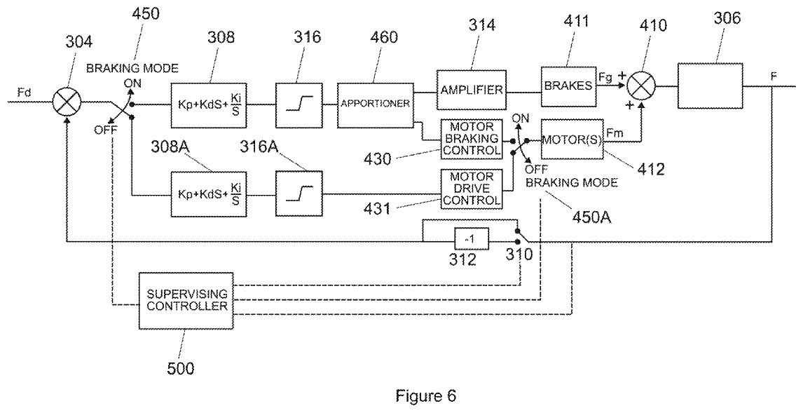

The trailer illustrated with reference to FIGS. 5 (a), (c) and (d) includes a battery 10 for storing electrical energy and suitable to power an electric motor 412 to propel the trailer. The electric motor 412 drives both of the wheels on the trailer via a differential comprised of pinion 481, crown wheel 480 and a differential gearset internal to the crown wheel (not shown) connected to the axle shafts which provide drive to each wheel. Housing 470 rigidly connects the electric motor 412 to the axle and houses the crown wheel 480, pinion 481 and other transmission elements. This type of transmission arrangement is well known to those skilled in the art. The electric motor 412 is capable of providing drive to propel the trailer via this arrangement, and also to provide regenerative braking. It does the latter by functioning as a generator where it converts kinetic energy to electricity. FIG. 5(b) is a flow diagram illustrating operation of components of a controlling system. An electric motor controller 435 (which incorporates the elements 430 and 431 shown in FIG. 6) is used to control the electric motor, both in propulsion and braking.

The trailer wheels are fitted with friction brakes 411. These are electrically actuated. The trailer hitch has a force sensor 110 (shown in FIG. 5a) which measures the force the trailer exerts on the vehicle towing it on the fore/aft direction.

FIG. 6 shows a block diagram of a suitable control system 201 for controlling the force at force sensor 110 to a desired value Fd. Typically, Fd is zero, although there may be times where a value other than zero is desired. This value may be different when the vehicle/trailer combination is braking or travelling along steadily under propulsive power.

The supervisory controller 500 (typically microprocessor based) determines whether the trailer should be braking, and in what scenario it is operating. When the controller determines that braking is required it turns the switches 450 and 450A ON. PID control block 308, clamp 316 (and other elements to optimally implement such a controller—e.g., anti wind-up, filtering etc) provide a signal representing the desired amount of braking to the apportioner 460. The apportioner 460 decides how much of the braking effort should be apportioned to the regenerative braking function of the electric motor and how much to the friction brakes. This apportioning may be based on a number of factors, such as maximisation of battery recharging (in which case the regenerative braking takes precedence), detection of an emergency braking event (in which case friction brakes may take precedence), battery charge level, brake temperature, electric motor and electric motor controller temperature, etc.

An alternative to using a single electric motor driving two wheels via a differential and axle arrangement as previously described is to use a separate electric motor directly driving each wheel. These are commonly called “wheel motors”. In that case one controller can drive each electric motor on the same axle, providing the same amount of propulsion force or braking at both wheels. However, it can be preferable to control the electric motors separately which enables features such as anti-lock braking and traction control to avoid loss of traction at a wheel. It can also be used to implement stability control, such as to counteract sway. Such systems are commonly used on vehicles as an adjunct to the normal braking and propulsion systems to control the vehicle in emergency situations such as those where traction is lost. Equally they can be applied in this system as an adjunct to the braking and propulsion systems described, indeed they may be implemented by the same controller.

The electric motor braking controller 430 includes electronics and electrical switching equipment that controls the electric motor 412 as a generator such that it can convert energy derived from braking the trailer into electricity at a level and characteristic that it then transfers to the battery (not shown in FIG. 6) to charge it. The electric motor braking controller 430 modulates the braking torque applied by the electric motor 412 to the wheels in accordance with the desired level of electric motor braking communicated to it by the apportioner 460. To assist in performing its function, the electric motor braking controller 430 may receive feedback from the electric motor 412, such as rotational position, back emf, and speed.

In a less preferred form the electric motor braking controller 430 does not transfer the energy collected at the electric motor during braking to the battery but instead dissipates it as heat which is then rejected to the surroundings.

Electric motor propulsion controller 431 includes electronics and electrical switching equipment that controls the energy supply from the battery (not shown in 6) to the electric motor such that the electric motor can propel the trailer. Electric motor propulsion controller 431 modulates the propulsion torque applied by the electric motor 412 to the wheels in accordance with the desired level of propulsion communicated to it by a PID control block 308A and as modified by elements such as the clamp 316A. PID control block 308A acts to control the electric motor 412 so that the force at the trailer hitch, as sensed by force sensor, at least approaches the desired value Fd. Typically, Fd will be set to, at or near zero. To assist in performing its function, the electric motor propulsion controller 431 may receive feedback from the electric motor 412, such as rotational position, back emf, and speed.

In one embodiment, the electric motor braking controller 430 and the electric motor propulsion controller 431 comprise the same hardware, configured to perform both the braking and propulsion functions. The braking forces Fg applied by the friction brakes 411, and the braking force Fm applied by the motor 412 combine, represented in FIG. 6 by summing point 410, to act on the force F to tend toward the desired force Fd.

The electric motor 412 may also assist with driving in reverse, as would be required when the driver is trying to drive the vehicle and trailer in reverse. This could be particularly useful when reversing uphill for example. Note that, unlike with braking, block 312 is not required (i.e., polarity of the feedback signal does not need to be reversed at any stage during operation) for driving in reverse as when reversing both the expected force direction at the force sensor and the direction of drive required at the electric motor 412 are both reversed. To illustrate this, when driving forwards a demand for increased forward propulsion at the electric motor 412 is required when the force sensor is in tension (negative signal). When reversing, tension at the force transducer also signifies that less forward propulsion is required (i.e., more reverse propulsion is required.)

Although the control blocks 308 and 308A are described and shown as PID controllers, other control algorithms may be used. Also, the entire controller, e.g., incorporating the PID control block 308, the PID control block 308A, the comparator 304, the switches 450 and 450A, the clamp 316, 316A, the apportioner 460 and the block 312 may be implemented on a microprocessor. In one embodiment this is the same microprocessor that implements the supervisory controller 500.

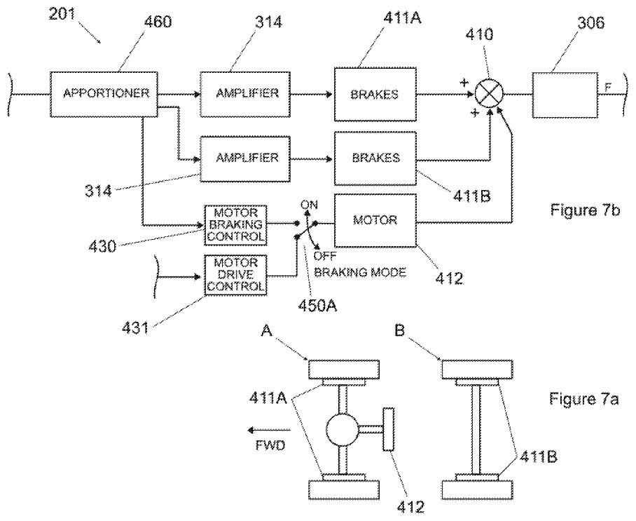

Some trailers have more than two wheels. Some may have four or six wheels on two or three axles respectively. It is possible to incorporate braking and propulsion on such trailers without fitting friction brakes or electric motors on all wheels. Indeed, on some trailers, brakes are only fitted to the leading axle. Equally an electric motor for providing propulsion may only be fitted to one axle, or even just one wheel, although that would be undesirable as it would tend to skew forces on the trailer to one side. In the case where the wheels that receive propulsion and those that have brakes are not the same, the apportioner 460 is used to apportion braking and propulsion needs to take that into account. Alternatively separate apportioners may be used for different wheels or sets of wheels. An example is shown in FIGS. 7(a) and (b) for a trailer having two axles A and B, where axle A is equipped with friction brakes 411A and an electric motor 412, while axle B has friction brakes 411B only. In the control system 201 the apportioner 460 now operates to apportion braking effort to the friction brakes 411A, 411B and the regenerative braking function of the electric motor 412. Propulsion provided by the electric motor 412 is controlled in the same manner as described above in relation to FIG. 6.

The following will describe the operation of the controller 201 for controlling braking of the trailer 104 in multiple scenarios. A first set of scenarios is described where the trailer is fitted with friction brakes and does not include a propulsion system. A second set of scenarios is described where the trailer has a propulsion system capable of providing braking in addition to or as an alternate for the friction brakes. This therefore contemplates the situation where for example the trailer has no mechanical brake but has a propulsion system which includes an electric motor that can provide regenerative braking and where the regenerative braking is sufficient by itself such that the force sensed by the force sensor can at least approach a desired force. A trailer propulsion system may be particularly useful when the trailer is being towed by an electric vehicle. The system may operate to control the force on the trailer by activation of the electric motor(s) of the trailer to provide propulsion to the trailer to maintain a desired force (e.g., zero at the trailer coupling) instead of the vehicle having to pull the trailer. This will minimise the load on the battery of the electric towing vehicle, and thus maximise the range of the vehicle/trailer combination over the case where the trailer has no propulsion system. The desired force may even be positive (i.e., compressive), such that the trailer pushes the vehicle, thereby reducing the power required from the vehicle's battery and thereby extending the vehicle's range.

### 1. First Set of Scenarios (Trailer has No Propulsion System)

In these scenarios the force in the hitch, as measured by the force sensor is described, as well as the speed of the vehicle/trailer combination.

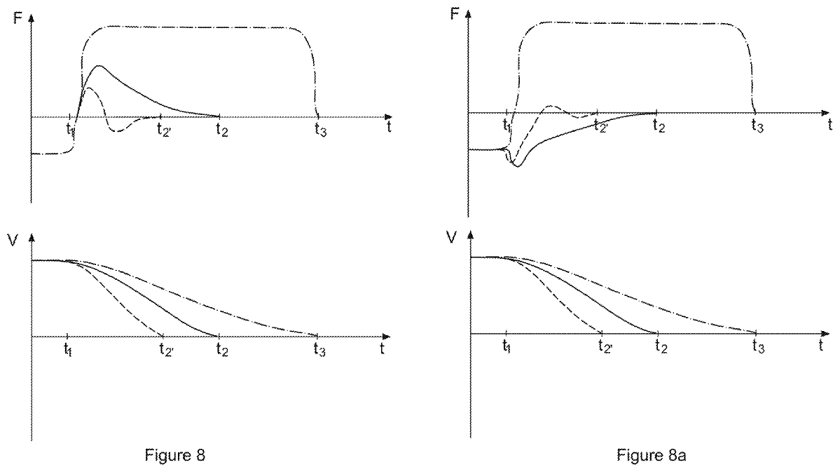

It is by no means a complete list of scenarios, just some that may occur in use. Some of the scenarios will be illustrated with reference to graphs shown in FIGS. 8-11. The graphs schematically illustrate:
A force as determined at a trailer hitch in the fore/aft direction (i.e., as sensed by the sensor 110 shown in FIG. 1); and
A velocity of the vehicle/trailer combination.

The shown graphs have signs, which relate to driving or force directions:
Velocity (V), positive is forwards
Force (F), positive is compression (e.g., the trailer pushes on the vehicle)

In the graphs, the dash-dot lines show force and velocity for the case in which exclusively the vehicle brakes (e.g., there are no trailer brakes) operate to effect the braking of the vehicle/trailer combination. The solid lines in the graphs show the case in which the system in accordance with embodiments of the present invention controls trailer brakes. The dashed lines signify that the controller of the system has identified the scenario as emergency braking and has utilised a control algorithm or gains that provide a faster response (e.g., a less damped (e.g., a smaller derivative term Kd in a PID controller) response). It should be noted that the graphs are not to scale—they are intended to illustrate the nature of the force and velocity response only. In actual use the graphs may vary significantly in scale and proportion, both within a graph and between graphs. The shape of the graphs will also vary depending on the characteristics of the control algorithm that is employed. In particular, oscillatory portions of the curves in the graphs may vary significantly depending on at least controller gains and the nature of the input perturbations to the system.

In the graphs shown in FIGS. 8-11 the following applies:

| Time | Event |
|---|---|
| t₁ | Point of vehicle brake application |
| t₂ | Vehicle/trailer combination comes to rest (v = 0), |
| | brake controller operating |
| t₂′ | Vehicle/trailer combination comes to rest (v = 0), |
| | brake controller operating in emergency braking |
| | scenario (dashed lines on graph). |
| t₃ | Vehicle/trailer combination comes to rest (v = 0), |
| | brake controller not operating |

Additionally, in all these figures the desired force the controller is controlling to is zero.

It should be noted that much of the discussion around control characteristics, system responses etc are well known to those skilled in the art.

### 1.1: Travelling Forwards, Horizontal Roadway

In this scenario, trailer brakes 210, 212, 214 and 216 are applied when the towing vehicle 102 is travelling forwards and its brakes are applied to slow down or stop. In this scenario the trailer 104 will tend to push the towing vehicle 102 unless the trailer brakes 210, 212, 214 and 216 are applied. This would be sensed by the force sensor 110 as a positive (compressive) force. The controller 201 will receive a corresponding force signal from the force sensor 110 and a signal from the brake light circuit 202; and, initiate braking of the brakes 210, 212, 214 and 216. As a consequence of activating the brakes 210, 212, 214 and 216, the force sensor 110 will sense a decrease in force and direct a reduced force signal to the controller 201. The controller 201 uses, in this embodiment, a PID control strategy or similar to vary the brake application until the force sensed by the force sensor 110 approximates a desired force. As previously mentioned, this is typically set to zero, but can be adjusted by a user.

Desirably the controller 201 is tuned (i.e., the PID gains are tuned) to provide an overdamped response to avoid force reversals which will lead to “clunking” as the longitudinal free play in the coupling oscillates between fore and aft clearance—and avoid the resulting adverse user perception. Ideally, the controller 201 will be tuned such that the response is overdamped but close to critically damped to ensure as rapid a response as possible—i.e., quickest application of maximum braking in an emergency to minimise stopping distance.

The following will discuss operation in case of emergency braking. If the force signal from the force sensor 110 indicates that braking of the towing vehicle 102 is heavy (such as by a very rapid increase in force, and/or force at a high level), the controller 201 may switch to an underdamped response to maximise the speed of application of the trailer brakes 210, 212, 214 and 216. In one embodiment of the invention, a feed forward element would be added to the controller to provide a faster response in situations such as emergency braking.

As already discussed, it is preferable that “clunking” associated with force reversals at the hitch are avoided. In the case of the vehicle and trailer driving forwards on a horizontal surface at a steady speed when the brakes are applied the use of a feed forward element, which may simply consist of a short burst of current to the brakes commencing at or shortly after the vehicle brakes are applied/brake light signal goes high, the hitch can be kept in tension for the entire braking event, thereby avoiding clunking. It will be understood that in this case the hitch is in tension immediately preceding the braking event due to the aerodynamic drag and rolling resistance on the trailer.

A more sophisticated control strategy can be used instead of a PID controller. An optimal control-based strategy such as Linear-Quadratic-Regulator could be used. Alternatively, strategies involving Model Predictive Control, or stochastic control-based options such as Linear Quadratic Gaussian control could be used.

FIG. 8 shows graphs illustrating the operation of the system in this scenario. Specifically, the dashed line in FIG. 8 which terminates at t₂, illustrates an embodiment where the supervisory controller recognises the situation as an emergency braking event (such as by detecting a rapid onset and high magnitude of hitch force subsequent to brake light on detection). The solid line in this graph shows the case where there is a more gentle and gradual application of the vehicle brakes, and where the controller does not recognise it as emergency braking. It shows a fairly heavily damped (e.g. a large derivative term Kd in a PID controller) response. The hitch force prior to time t₁ shows the force required to pull the trailer along at a steady-state speed. The speed of the vehicle and trailer will decrease at a fairly steady/constant rate—assuming that the amount of brake pedal pressure applied by the vehicle driver stays fairly constant and the brakes don't overheat or otherwise lose effectiveness. The braking pedal pressure would be higher in the case of the emergency braking scenario (dashed lines). It should be noted that in this example the dot-dash line terminating at t₃ shows the emergency braking case (with no trailer brakes operating) rather than the more gradual and gentle case.

All the cases shown show a force reversal in the hitch. Prior to braking the hitch is in tension due to the drag of the trailer. When the vehicle starts braking the hitch becomes loaded in compression before the trailer braking force ramps up. In the case of the underdamped response there may be subsequent force reversals as the amount of braking force applies oscillates, as shown by the dotted line. In one embodiment of the invention feed-forward or pre-emptive braking is applied as soon as the brake light signal is detected. This can be used to prevent or reduce force reversals. This is shown in FIG. 8a where it can be seen that the application of braking results in an initial increase in tension in the hitch and a force reversal is avoided in the underdamped case.

The following will discuss the case of increased weight of the trailer 104. Over an extended period of time, spanning many brake applications, the force signal from the force sensor 110 may indicate that the force changes more slowly following application of the trailer brakes 210, 212, 214 and 216, indicating the likelihood of a heavier load in the trailer 104. The controller 201 may then increase the gain to compensate. In the inverse scenario in which the trailer weight is reduced, the controller 201 may reduce the gain accordingly. That is, embodiments of the disclosed system 100 are adaptive in that they learn and can self-adjust to operate in an optimal manner when load or other characteristic change.

### 1.2: Travelling Forward Downhill to Maintain Speed

In this scenario, the trailer brakes 210, 212, 214 and 216 are applied when travelling forwards downhill to maintain speed (i.e., to prevent speed increasing or increasing too much). The controller 201 then receives a force signal from the force sensor 110 indicating that, as the trailer brakes 210, 212, 214 and 216 are applied, the force sensed decreases with increasing braking of the trailer brakes 210, 212, 214 and 216. A PID control strategy or similar is used by the controller 201 to vary the brake application to control the force to the desired amount. Typically, this will be set to zero. However, it may be desired that this is varied from zero when extended brake application is detected, such as tends to happen on a long descent. Often trailer brakes will tend to overheat and lose effectiveness faster than the brakes on the vehicle 102—also the vehicle 102 can perform at least some of its braking by engine braking (or regeneration in the case of an electric or hybrid vehicle)—so it is desirable to allow the vehicle 102 to provide a greater proportion of the braking on long downhill inclines (declines). In this case the controller 201 may be configured to automatically adjust the desired force at the coupling to allow the trailer 104 to push on the vehicle 102 to the desired extent when the controller 201 by receipt of signals from the force sensor 110 determines the long decline. The desired extent may be user adjustable and/or may be varied about the user set point or a fixed set point by the controller 201 depending on the length of the decline (i.e., elapsed time of braking). Alternatively, the user may instigate the change in desired force by manually inputting this to the controller's user interface. In one form this may be prompted by an audible or visual alert from the user interface alerting the driver that it has detected a long decline. Such a manual intervention may automatically be switched back to the default value after a given time, or the controller may do it when it detects the decline has ended.

A decline can be sensed by the controller 201 if the force sensor 110 senses that the sensed force is not reducing on brake application as quickly as normal as the trailer 104 pushes the vehicle 102. The controller 201 can also sense that the integral of force with time for application of the brakes 210, 212, 214 and 216 is larger than usual without the force at the coupling reducing to the desired level. In yet another form, of the invention, the presence of a long decline may be detected from position data such as from a GPS and mapping information that is received and monitored by the controller.

In one form of the invention the controller may adapt to the slope of the road by changing the gain of the controller. On a decline it may increase the gain and on an incline it may decrease the gain to provide optimum braking effort for the current slope.

In one specific variation of the described embodiment the trailer brake temperatures are monitored and if overheating is detected, a greater portion of the braking effort can be shifted to the towing vehicle 102, preventing or minimising the risk of the trailer brakes 210, 212, 214 and 216 losing effectiveness or failing due to excessive temperatures. The brake effort can be shifted to the towing vehicle 102 by changing the desired force to a positive value. The brake temperature can be sensed by monitoring the electrical resistance of electromagnet coils in the trailer brakes—as they get hot their resistance will increase. This has the advantage that there is no need to add dedicated temperature sensors to the brakes 210, 212, 214 and 216.

### 1.3: Travelling Forwards, Engine Braking

In this scenario the trailer brakes 210, 212, 214 and 216 can be applied even when the brakes of the vehicle 102 are not applied. The vehicle 102 may be using engine braking (or EV/hybrid regenerative braking) solely to retard its forward motion. This typically would not cause the brake lights to be switched on (in other operating scenarios sensing vehicle brake application via the brake light input to the controller is typically a prerequisite to application of the trailer brakes by the controller). The sensing of a sustained positive force at the force sensor 110 can be used to recognise vehicle engine braking down a long decline. The controller can then effect application of the trailer brakes 210, 212, 214 and 216 such that the sensed force is reduced to the desired level. In this embodiment the controller 201 may activate the trailer brake lights when the trailer brakes are being operated in this manner.

### 1.4: Reversing

In this scenario the trailer brakes 210, 212, 214 and 216 are applied whilst reversing to slow down or stop when the vehicle brakes are applied. Here the signal generated by the force sensor 11 indicates that the force sensed increases the more the trailer brakes 210, 212, 214 and 216 are applied. This is the reverse of a typical and more common brake use when slowing down travelling in a forward direction (as in the above-described first and second scenarios) and this requires the controller 201 to adapt to implement a reversal of the polarity of the feedback into the controller 201. This can be done electronically (in hardware via switching) or by simply changing the sign in a digital algorithm on a microprocessor in the controller. A PID control strategy or similar is used to vary the brake application to control the force to the desired amount. Typically, this desired amount will be set to zero.

### 1.5: Rolling Backwards Downhill

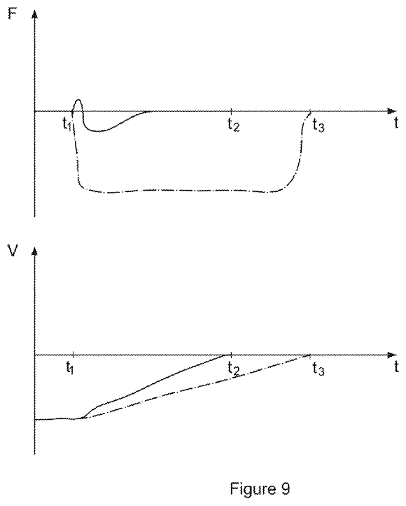

This scenario is illustrated by graphs shown in FIG. 9 and is instigated by the detection of brake lights turning ON. The reversing lights are not necessarily ON. On initial application of the trailer brakes, the force in the hitch will tend to increase rather than decrease, as would occur if there was forward motion. This will be detected by the supervisory controller. It will then respond by reversing the polarity of the force sensor feedback in the control loop. This will result in effective (i.e., negative feedback) control. This will enable the controller to rapidly reduce the force at the hitch to zero (approximately) by modulating the braking effort at the trailer brakes.

As the vehicle and trailer come to rest it is likely that the force at the hitch will remain at approximately zero. However, it is possible that with some compliance in the system (i.e. suspension, hitch, tyres, etc) that it will settle at a non-zero value. Given the downhill attitude (in direction of last direction of travel), it is maybe more likely that this would be a negative force (i.e., there is tension) at the hitch, as the trailer may pull on the vehicle. FIG. 9 shows the case where the force at the hitch settles to zero.

### 1.6: Reversing Uphill

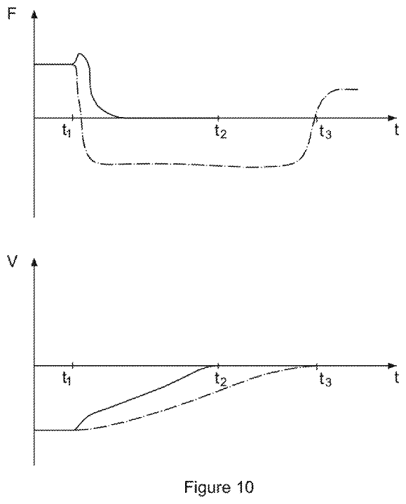

This scenario involves the vehicle and trailer reversing uphill and the driver applying the vehicle brakes in order to stop. This is illustrated by graphs shown in FIG. 10. The braking by the trailer controller is instigated by the detection of brake lights turning ON. The reversing light will also be ON.

On application of the trailer brakes, the force in the hitch will tend to increase rather than decrease, as would occur if there was forward motion. This will be detected by the supervisory controller. It will then respond by reversing the polarity of the force sensor feedback in the control loop. This will result in effective (i.e., negative feedback) control. This will enable the controller to rapidly reduce the force at the hitch to zero (approximately) by modulating the braking effort at the trailer brakes. In one embodiment the supervisory controller will reverse the polarity of the force sensor feedback in response to detecting that the reverse lights are on.

As the vehicle and trailer come to rest it is likely that the force at the hitch will remain at approximately zero. However, it is possible that with some compliance in the system (i.e. suspension, hitch, tyres, etc) that it will settle at a non-zero value. Given the uphill attitude (in direction of last direction of travel), it is maybe more likely that this would be a positive force (i.e., there is compression) at the hitch, as the trailer may push on the vehicle. FIG. 10 shows the case where the force at the hitch settles to zero.

It should be noted that the initial increase in compressive force shown in FIG. 10 may be avoided by using the polarity reversal on the detection of reversing lights as described above, and particularly if a feed forward system, such as that described in 1.1, is employed.

### 1.7: Travelling Forward Downhill to Stop the Vehicle and Trailer

In this scenario, the trailer brakes 210, 212, 214 and 216 are applied to stop the vehicle and trailer when travelling forwards downhill when the vehicle brakes are applied.

Here the trailer brakes 210, 212, 214 and 216 will function in the same way as in the above-described in scenario 1.2 above, except in this case greater vehicle brake application results in the vehicle and trailer coming to a stop. When stationary on a downhill slope it is desirable that the trailer brakes assist in stopping the towing vehicle 102 and trailer 104 from rolling forwards. This is particularly so on slippery surfaces when the wheels of the towing vehicle 102 lose traction and skid when braking. Given imperfect traction at the vehicle wheels, if the trailer 104 pushes the towing vehicle 102, a resultant force will cause the trailer braking to be increased until it stops rolling and stops pushing the towing vehicle 102. As described above, the integral (I) term in the controller 201 will facilitate trailer braking whilst the force at the force sensor reduces to zero or near zero. In this scenario little or no adaption is required by the controller 201 set up over that described for the second driving condition at 1.2, above for it to function successfully. However, on sensing an extended duration of brake operation and force sensor 110 inputs consistent with being stopped on a downhill incline, the controller 201 may vary the gain to optimise trailer braking in a “hold” function to avoid the trailer 104 either pushing or pulling the towing vehicle 102 to any significant extent whilst avoiding overheating of the electromagnets at the brakes due to ohmic heating.

### 2. Second Set of Scenarios (Trailer has Propulsion System)

This section describes scenarios where the trailer is fitted with a propulsion system in addition to friction brakes. In this scenario the force in the hitch, as measured by the force sensor is described, as well as the speed of the vehicle/trailer combination.

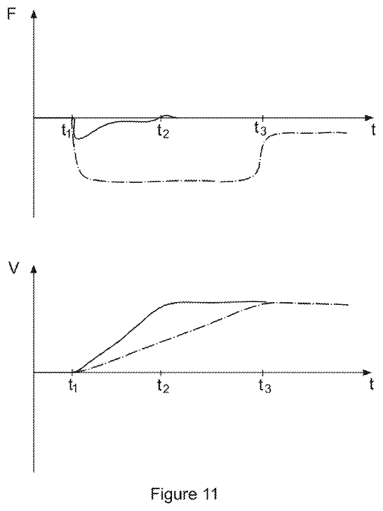

One scenario will be illustrated with reference to the graphs shown in FIG. 11. The Graphs schematically illustrate:
A force F as determined at a trailer hitch in the fore/aft direction (i.e., as sensed by the sensor 110 shown in FIG. 1); and
A velocity V of the vehicle/trailer combination.

The shown graphs have signs, which relate to driving or force directions:
Velocity, positive is forwards
Force, positive is compression (e.g., the trailer pushes on the vehicle)

In the graph, the dash-dot lines show force and velocity for the case in which exclusively the vehicle brakes and provides propulsion (e.g., there are no trailer brakes nor a trailer propulsion system). The solid lines show the case where our brake controller is operating the trailer propulsion system and the friction brakes.

It should be noted that the graph is not to scale—the graph is intended to illustrate the nature of the force and velocity response only. In actual use the graph may vary significantly in scale and proportion. The shape of the graphs will also vary depending on the characteristics of the control algorithm that is employed.

In all of the graphs the following applies:

| Time | Event |
|---|---|
| t₁ | Point of application of vehicle propulsive force |
| t₂ | Vehicle/trailer combination reaches desired speed |
| | (controller operating) |
| t₃ | Vehicle/trailer combination reaches desired speed |
| | (controller not operating). |

Additionally, the desired force the controller is controlling to is set to zero.

2.1 Accelerating from Rest to a Steady Speed, Horizontal Surface

This scenario is illustrated in FIG. 11.

In this scenario the towing vehicle accelerates from rest with a constant level of propulsion force at its drive wheels. The force reduces, as the vehicle reaches its desired speed, to the level required to maintain this speed.

In the case where trailer propulsion is active (solid lines), the same level of propulsion force is applied by the vehicle. The controller controls the trailer propulsion system to keep the force in the hitch as close as possible to the desired force (zero in this example). The resulting acceleration is higher (i.e., the velocity curve is steeper) due to the contribution of the trailer propulsion.

In a further variation the system may also comprise an accelerometer, which can be used to detect inclines and declines. In this embodiment the accelerometer may generate an output signal received by the controller 201, which is arranged to use the accelerometer output signal as a further signal (not only the signal generated by the force sensor 110) that can be processed by the controller and used to determine the force to be applied to the trailer. In yet another variation a speed sensor may be used. The speed sensor may take the form of a wheel speed sensor, at one or more of the wheels, such as those commonly used with vehicle anti-lock braking systems. Alternatively, a speed sensor based on a global positioning system (GPS) can be used. The speed sensor may also generate an output signal directed to the controller 201. For example, the controller, utilising speed sensor input may be used to detect inclines or declines by detecting that it is taking less or more braking effort to decelerate the vehicle. This information can be used by the supervisory controller to determine the optimal gain to be used.

The speed sensor can also inform the controller of the direction of travel, making it easier to determine which operating scenario it is operating in. This can assist, for example, with the supervisory controller being able to determine the required polarity of force feedback earlier, and avoid a jolt being felt by users associated with the incorrect polarity prior to switching. Detection of when the vehicle and trailer have come to a stop is also easier. This can be used by the supervisory controller to vary gain as required from braking function to a “hold” function, thereby avoiding overheating of the brakes.

A person skilled in the art will appreciate that variations of the described embodiments are possible.

1-37. (canceled)

38. A system for controlling a force applied on a trailer being towed by a vehicle, the system comprising:
a force sensor configured to sense a force between the vehicle and the trailer and being arranged to generate an electrical force signal as a function of the force; and
a controller in electrical communication with the force sensor, the controller arranged to control: (a) at least one propulsion system of the trailer; or (b) at least one brake of the trailer; or (c) both at least one propulsion system and at least one brake of the trailer, in a manner such that the force sensed by the force sensor at least approaches a desired force; wherein the system is arranged for sensing a quantity indicative of a temperature or a change in temperature of a portion of the at least one brake of the trailer.

39. The system of claim 38, wherein the system comprises a sensing element mechanically or hydraulically coupled to a coupling between the vehicle and the trailer that directly experiences the force between the vehicle and the trailer, the sensing element further coupled to the force sensor whereby the force sensor can be located remotely from surfaces which directly experience the force between the vehicle and the trailer.

40. The system of claim 39, wherein the force sensor comprises a mechanical arrangement, the mechanical arrangement being a compliant member or spring, and a displacement sensor.

41. A system for controlling a force applied on a trailer being towed by a vehicle, where the trailer includes at least one electric motor for providing either propulsion or a braking force to the trailer by way of a regenerative braking function, and at least one friction brake for applying a braking force to the trailer, the system comprising:
a force sensor configured to sense a force between the vehicle and the trailer and being arranged to generate an electrical force signal as a function of the force; and
a controller in electrical communication with the force sensor, the controller arranged to control: (a) the at least one electric motor to provide either propulsion to the trailer or a braking force on the trailer by way of a regenerative braking function; or (b) the at least one friction brake of the trailer to apply a braking force on the trailer; or (c) the at least one electric motor and the at least one friction brake of the trailer to both apply a braking force to the trailer, in a manner such that the force sensed by the force sensor at least approaches a desired force; and wherein when the controller controls the at least one electric motor and the at least one friction brake of the trailer, the controller controls the at least one electric motor and the at least one friction brakes such that a first portion of the braking force is provided by the friction brakes and a second portion of the braking force is provided by a regenerative braking function of the at least one electric motor, and wherein the system has an apportioner which determines a relative size of the first portion and the second portion of the braking force.

42. The system of claim 41, wherein the system comprises a sensing element mechanically or hydraulically coupled to a coupling between the vehicle and the trailer that directly experiences the force between the vehicle and the trailer, the sensing element further coupled to the force sensor whereby the force sensor can be located remotely from surfaces which directly experience the force between the vehicle and the trailer.

43. The system of claim 42, wherein the force sensor comprises a mechanical arrangement, the mechanical arrangement being a compliant member or spring, and a displacement sensor.

44. The system of claim 41, when the trailer includes a propulsion system, the controller controls the propulsion system such that the propulsion system is able to provide a braking force on the trailer.

45. The system of claim 44, wherein when the trailer comprises friction brakes, the system for controlling the force is arranged to control the at least one electric motor and the friction brakes such that a first portion of the braking force is provided by the friction brakes and a second portion of the braking force is provided by the regenerative braking function of the at least one electric motor.

46. The system of claim 41, comprising a rechargeable battery on the vehicle or the trailer and wherein the apportioner determines a relative size of the first portion of the braking force provided by the friction brakes and the second portion of the braking force provided by the regenerative braking function of the at least one electric motor in a manner such that a charge of the battery is maximised.

47. The system of claim 41, wherein the at least one propulsion system comprises two or more electric motors and wherein the system is arranged to provide at least one of anti-lock braking or traction control of the trailer, and the controller is arranged to modulate control signals to the two or more electric motors separately to implement stability control or anti-sway functionality of the trailer.

48. A system for controlling a force applied on a trailer being towed by a vehicle, the system comprising:
a force sensor configured to sense a force between the vehicle and the trailer and being arranged to generate an electrical force signal as a function of the force; and
a controller in electrical communication with the force sensor, the controller arranged to control: (a) at least one propulsion system of the trailer; or (b) at least one brake of the trailer; or (c) both at least one propulsion system and at least one brake of the trailer, in a manner such that the force sensed by the force sensor at least approaches a desired force (i) when the vehicle is traveling in a forward direction, and (ii) when the vehicle is traveling in a reverse direction; and
wherein the system is arranged to reverse polarity of a signal in the controller when the vehicle is traveling in a reverse direction.

49. The system of claim 48, wherein the signal is the electrical force signal and system is arranged to determine the direction of travel of the vehicle and to reverse a polarity of the electrical force signal when the vehicle is traveling in a reverse direction in comparison to a polarity of the electrical force signal when the vehicle is traveling in a forward direction.

50. The system of claim 48, comprising at least one of drawbar or a coupling for coupling the vehicle and the trailer to each other, wherein the force sensor is in use located in or at the drawbar or the coupling and is configured to sense a substantially longitudinal force between the vehicle and the trailer.

51. The system of claim 48, wherein (a) the desired force is substantially zero, or (b) the controller is arranged to enable a user to input signals to the controller to adjust the desired force while the user is driving the vehicle.

52. The system of claim 48, wherein the system is arranged to sense a measure for the temperature of the brakes by sensing electrical resistance of an electromagnet coil used in the brakes.

53. The system of claim 52, wherein the controller is arranged to (a) control braking of the trailer based on a temperature sensed at the at least one brake of the trailer: or (b) to reduce braking of the at least one brake of the trailer when the temperature sensed at the at least one brake of the trailer is above a predetermined threshold temperature.

54. The system of claim 48, wherein, the trailer includes at least one electrically actuated brake, and the system for controlling the force is directly or indirectly electrically coupled to the at least one electrically actuated brake.

55. The system of claim 48, wherein the controller and the force sensor form part of a feedback loop in which the controller controls the force applied to the trailer such that at least one of an actual or sensed force tends towards the desired force over time.

56. The system of claim 48, wherein the controller is provided with a variable gain to vary the force applied on a trailer to achieve the desired force, wherein the gain is varied dependent on one or both of a sensed variation in: an incline of travel of the trailer; or a change in mass of the trailer.

57. The system of claim 48, wherein the system comprises a sensing element mechanically or hydraulically coupled to a coupling between the vehicle and the trailer that directly experiences the force between the vehicle and the trailer, the sensing element further coupled to the force sensor whereby the force sensor can be located remotely from surfaces which directly experience the force between the vehicle and the trailer.

58. The system of claim 57, wherein the force sensor comprises a mechanical arrangement, the mechanical arrangement being a compliant member or spring, and a displacement sensor.

59. The system of claim 48, wherein the system is arranged, upon sensing a change in direction of the electrical force signal when the at least one brake of the trailer is applied, to implement the reversal of polarity by reversing a sign of one or more terms in an algorithm operated by the controller.
